(19) United States
(12) Patent Application Publication
(10) Pub. No.: US 2007/0127663 A1
(43) Pub. Date: Jun. 7, 2007

(54) Method and system for providing service menu in communication system

(75) Inventors: Su-Jin Bae, Suwon-si (KR); Young-Ky Kim, Seoul (KR); Young-Ki Jeon, Hwaseong-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/598,905

(22) Filed: Nov. 14, 2006

(30) Foreign Application Priority Data
Nov. 14, 2005 (KR) 108818/2005

(51) Int. Cl. H04M 3/42

(52) U.S. Cl. 379/201.01

(57) ABSTRACT

A method and system for providing service menu information when an alerting service is provided between a calling terminal and a called terminal are provided. For this includes transmitting, by a calling terminal, a call setup request message including a service menu request; comparing, by a first server, service capability information of the calling terminal with service capability information of a called terminal, when it is necessary to evaluate the service capability information of the calling and called terminals, upon receipt of the call setup request message; and providing, by the first server, service menu to the calling and called terminals according to the comparison.

### PRIORITY

This application claims priority under 35 U.S.C. § 119 to an application filed in the Korean Intellectual Property Office on Nov. 14, 2005 and assigned Serial No. 2005-108818, the contents of which are incorporated herein by reference.

### BACKGROUND OF THE INVENTION

1. Field of the Invention

The present invention relates generally to a communication system, and in particular, to a method and system for providing service menu when an alerting service is provided between a calling terminal and a called terminal.

2. Description of the Related Art

Internet Protocol Multimedia Subsystem (IMS) is a system that provides IP-based packet communication services. IMS operates by a text-based application layer control protocol, Session Initiation Protocol (SIP). SIP is based on a client/server mechanism in which a server responds when clients start to page. SIP enables one or more participants to set up, amend and end a session, which can be a remote conference, a call, an interview or an event notification over the Internet.

In an SIP-based multimedia telephony environment, a 180 Ringing message is used to carry a ring-back tone to a calling terminal. The calling terminal generates a local ring-back tone or reproduces ring-back tone data carried by the 180 Ringing message, and provides it to a user.

When the calling terminal requests a call, it receives a default ring-back tone or a ring-back tone preset by a caller/called in a legacy communication system such as Public Switched Telephone Network (PSTN), Code Division Multiple Access (CDMA) or Wideband CDMA (WCDMA).

An existing alerting service provides a different alerting to a different subscriber, or on a day/time basis or occasionally. Also, an alerting can be provided by a user's voice. Yet, since the alerting of terminals is not customized to users' configurations and preferences, it is limited and monotonous.

The conventional communication system provides bell sounds or ring-back tones to the calling terminal and the called terminal with no regard to users' demands, preferences and tastes. This is attributed to limited terminal performance and limited alerting resources. Since no consideration is given to the preferences of the caller, a service situation and a service environment, no diverse service scenarios can be provided to the calling and called terminals. However, along with the evolution from 3^{rd} Generation (3G) communication systems to 4^{th} Generation (4G) communication systems, terminals have been updated to high performance. Also, users demand higher service levels.

The diversification of communication schemes is a driving force behind diversification of terminal types and even a single terminal is configured to be enabled with different communication schemes. Yet, even if a terminal is a composite terminal enabled with different communication schemes, it just adopts a selected communication scheme without compatibility between the different communication schemes. Therefore, if the calling terminal and the called terminal operate in different communication schemes, communication is impossible between them.

In other words, under an IP multimedia environment, limited services are available to the calling and called terminals and there is no way to determine which communication scheme the other party supports and which communication scheme is available at present. When the calling terminal attempts to call the called terminal in its intended communication scheme, the discrepancy between communication schemes may make it impossible to communicate with the called terminal.

### SUMMARY OF THE INVENTION

An object of the present invention is to substantially solve at least the above problems and/or disadvantages and to provide at least the advantages below. Accordingly, the present invention provides a method and system for providing service menu, considering the subscriber service capability information of calling and called terminals and considering whether services are permitted, when a multimedia alerting is provided.

According to the present invention, there is provided a method for providing a service menu in a communication system. The method includes transmitting, by a calling terminal, a call setup request message including a service menu request; comparing, by a first server, service capability information of the calling terminal with service capability information of a called terminal, when it is necessary to evaluate the service capability information of the calling and called terminals, upon receipt of the call setup request message; and providing, by the first server, service menu to the calling and called terminals according to the comparison.

According to the present invention, there is provided a method for providing a service menu in a communication system. The method includes setting, by a calling terminal, to receive service menu by a ring-back tone and transmitting a call setup request including a service menu request; comparing, by a first server, service capability information of the calling terminal with service capability information of a called terminal, upon receipt of the call setup request from the calling terminal, when it is necessary to evaluate the service capability information of the calling and called terminals; and providing, by a first server, common service capability information as service menu to the calling terminal, if the calling and called terminals have common services.

According to the present invention, there is a method for providing a service menu in a communication system. The method includes setting, by a called terminal, to receive service menu by a bell; comparing, by a first server, service capability information of a calling terminal with service capability information of the called terminal, upon receipt of a call setup request from the calling terminal, when it is necessary to evaluate the service capability information of the calling and called terminals; and providing, by a first server, common service capability information as service menu to the called terminal, if the calling and called terminals have common services.

According to the present invention, there is a method for receiving service menu in a communication system. The method includes determining, upon receipt of a message including alerting information, whether the alerting information includes service menu information; determining whether the service menu information is common service information or service capability information of a called terminal, if the alerting information includes the service menu information; and displaying a service menu according to the service menu information is service menu, if the service menu information is the common service information.

According to the present invention, there is a method for receiving service menu in a communication system. The method includes determining, upon receipt of a message including alerting information, whether the alerting information includes service menu information; determining whether the service menu information is common service information or service capability information of a calling terminal, if the alerting information includes the service menu information; and displaying a service menu according to the service menu information is service menu, if the service menu information is the common service information.

According to the present invention, there is a system for providing a service menu in a communication. The system includes a first server including a calling terminal and a called terminal, for comparing service capability information of the calling terminal with service capability information of the called terminal, when it is necessary to evaluate the service capability information of the calling and called terminals, and providing service menu to the calling and called terminals according to the comparison; and a second server for providing the service capability information of the calling and called terminals to the first server.

According to the present invention, there is a system for providing a service menu in a communication system. The system includes a calling terminal for setting to receive service menu and transmitting a call setup request including a service menu request; a called terminal for setting to receive the service menu by a bell, receiving the service menu and outputting the service menu by a bell; a first server for comparing service capability information of the calling terminal with service capability information of the called terminal, upon receipt of the call setup request from the calling terminal, when it is necessary to evaluate the service capability information of the calling and called terminals, and providing common service capability information as the service menu to the calling terminal if the calling and called terminals have common services; and a second server for providing the service capability information of the calling and called terminals to the first server.

According to the present invention, there is a system for providing a service menu in a communication system. The system includes a calling terminal for being set to receive service menu by a ring-back tone and transmitting a call setup request including a service menu request; a called terminal for being set to receive the service menu by a bell, receiving the service menu, and outputting the service menu by a bell; a first server for comparing service capability information of the calling terminal with service capability information of the called terminal, upon receipt of the call setup request from the calling terminal, when it is necessary to evaluate the service capability information of the calling and called terminals, and providing common service capability information as the service menu to the called terminal if the calling and called terminals have common services; and a second server for providing the service capability information of the calling and called terminals to the first server.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a communication system for providing service menu by a ring-back tone and a bell sound according to the present invention;

FIG. 2 is a flowchart illustrating an operation for configuring a service menu when a Personal IMS Portal (PIP) server provides a ring-back tone to a calling terminal according to the present invention;

FIG. 3 is a flowchart illustrating an operation for configuring a service menu when the PIP server provides a bell sound to a called terminal according to the present invention;

FIG. 4 is a flowchart illustrating an operation for displaying a service menu received from the PIP server in the calling terminal or the called terminal according to the present invention;

FIG. 5 illustrates a display of service menu provided by a ring-back tone according to the present invention; and

FIG. 6 illustrates a display of service menu provided by a bell sound according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention provides a method and system for providing service menu by a bell or a ring-back tone according to the service capabilities of the users of calling and called terminals and considering whether services are permitted to the other party, when an alerting service is provided in a communication system, for example, an IMS communication system. While the present invention is described in the context of the IMS communication system, it is to be appreciated that the method and system for providing a service menu according to the present invention is applicable to other communication systems.

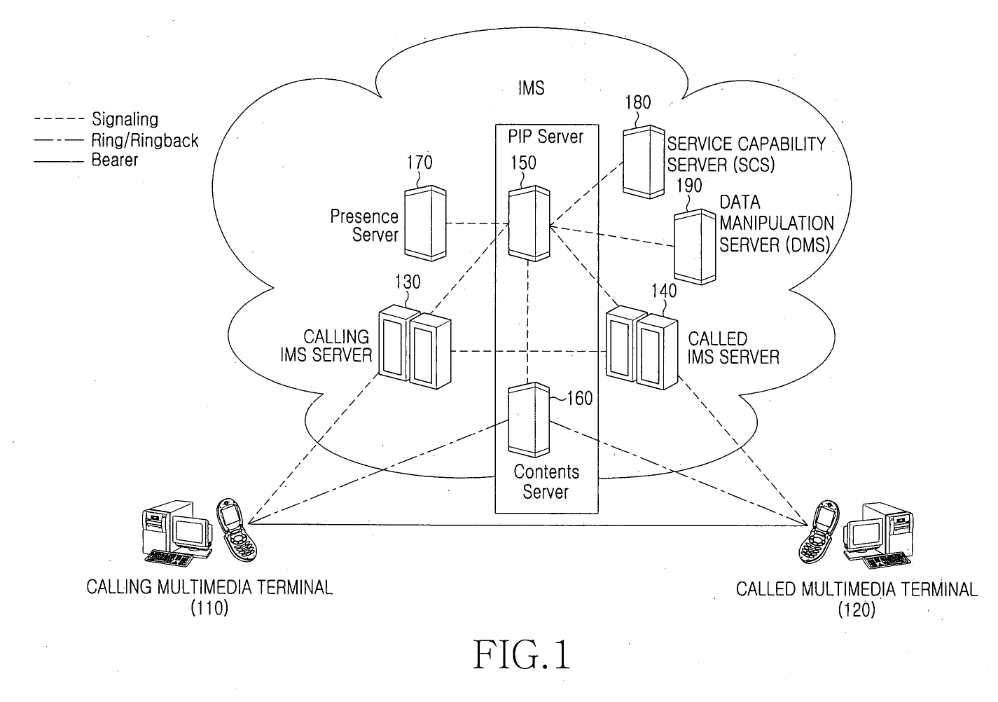

FIG. 1 illustrates the configuration of a communication system for providing service menu according to the present invention.

Referring to FIG. 1, the communication system includes a calling terminal 110, a called terminal 120, a calling IMS server 130, a called IMS server 140, a PIP server 150 and a contents server 160. The calling and called terminals 110 and 120 are enabled with multimedia features and the calling and called IMS servers 130 and 140 process a session between the calling and called terminals 110 and 120. The PIP server 150 provides multimedia portal contents to the calling and called terminals 110 and 120. The contents server 160 maintains and manages contents resources. A presence server 170 maintains and manages the status information of the users. A Service Capability Server (SCS) 180 can be added when the present invention is implemented in a real communication environment. It maintains and manages the service capability information of services subscribed to by the users. A Data Manipulation Server (DMS) 190 stores the subscriber information of a group to which each terminal belongs and the access information and service priority information of the group. The SCS 180 may co-function as the DMS 190. While not shown, the PIP server 150 can interwork with servers required for individual services, for example, an Instant Messaging (IM) server, a Location-Based Service (LBS) server and a Push-To-All (PTA) server.

The calling terminal 110 and the called terminal 120 are wired, wireless or dual wired/wireless terminals. They have enough processing power to reproduce multimedia portal contents. The calling terminal 110 and the called terminal 120 are equipped with the functions of audio/video recording and reproduction and are able to send/receive particular multimedia by the header of an SIP message. The calling and called terminals 110 and 120 authenticate with a Uniform Resource Locator (URL) being the address of the PIP server 150 or the contents server 160, received by the header of an SIP message. They are also able to receive an alerting service from the PIP server 150.

The calling and called IMS servers 130 and 140 are responsible for setting up and releasing a call between the calling terminal 110 and the called terminal 120. They interwork with the PIP server 150 according to the service profiles of the users when a predetermined alerting is needed for the calling and called terminals 110 and 120.

The PIP server 150 provides a multimedia alerting to the calling and called terminals 110 and 120. Upon request from the calling and called IMS servers 130 and 140, the PIP server 150 sends multimedia to the calling and called terminals 110 and 120. In addition, the PIP server 150 provides the multimedia alerting to the calling and called terminals 110 and 120 in conjunction with an external media server or the contents server 160.

The contents server 160 maintains and manages multimedia portal contents including HyperTest Transfer Protocol (HTTP), Wireless Application Protocol (WAP), and flash animation as well as audio, video, images and messages. The contents server 160 is preferably incorporated into the PIP server 150.

The presence server 170 manages the presence information (i.e. status information) of the terminals. Upon request from the PIP server 150, the presence server 170 provides the presence information of a corresponding terminal.

The SCS 180 manages the service capability information of the terminals. Upon request from the PIP server 150, the SCS 180 provides the service capability information of a corresponding terminal. In addition, the SCS 180 stores information indicating whether each subscribed service is permitted, for each terminal, and provides the stored communication permission information, upon request. Instead of the SCS 180, the DMS 190 or any other server can store and provide the service capability information and the communication permission information.

The DMS 190 stores and manages the subscriber information, the access information and the service priority information of a group to which each terminal belongs, and provides the PIP server 150 with the group subscriber information, group access information, and service priority information of each terminal.

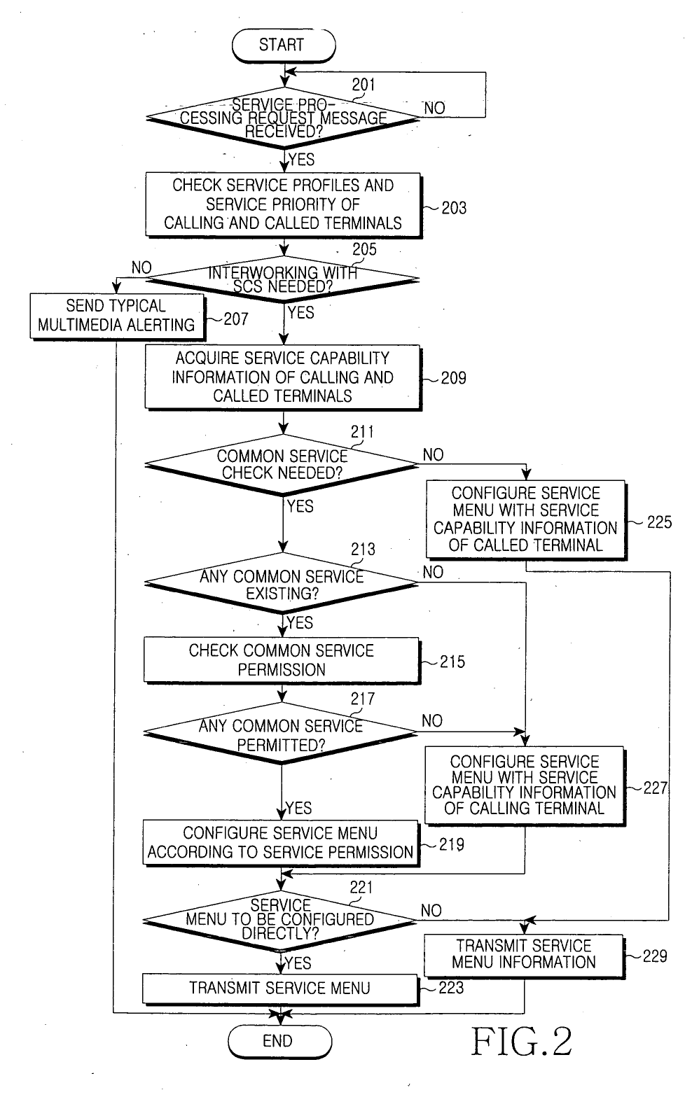

FIG. 2 is a flowchart illustrating an operation for configuring a service menu when the PIP server 150 provides a ring-back tone to the calling terminal 110 according to the present invention.

Referring to FIG. 2, the PIP server 150 monitors reception of a service processing request message requesting a ring-back tone from the calling terminal 110 in step 201. Upon receipt of the service processing request message, the PIP server 150 queries the DMS 190 about the service profiles and service priority of the calling and called terminals 110 and 120 in step 203.

In step 205, the PIP server 150 determines whether to interwork with the SCS 180, that is, whether the calling terminal 110 has been set to receive service menu by providing an alerting service. If the calling terminal 110 is set to receive the service menu, the PIP server 150 proceeds to step 209. If the calling terminal 110 is not to receive the service menu, the PIP server 150 configures a typical multimedia alerting and transmits it to the calling terminal 110 in step 207.

If the PIP server 150 determines to interwork with the SCS 180 in step 205, it acquires the service capability information of the calling and called terminals 110 and 120 in step 209 and determines whether to perform a common service check between the calling terminal 110 and the called terminal 120, considering common service check setting information preset by the calling terminal 110 in step 211. If the common service check is needed, the PIP server 150 proceeds to step 213. If the common service check is not needed, the PIP server 150 configures service menu with the service capability information of the called terminal 120 in step 225 and then proceeds to step 229.

In step 213, the PIP server 150 determines whether there is any common service between the calling terminal 110 and the called terminal 120. For example, if PTA, IM and LBS are available to the calling terminal 110, and PTA and IM are available to the called terminal 120, the PIP server 150 determines the existence of common services between them in step 213. That is, the PIP server 150 is aware that PTA and IM are common to the calling and called terminals 110 and 120, and LBS is confined to the calling terminal 110.

In the presence of any common service, the PIP server 150 determines whether the calling terminal 110 and the called terminal 120 each have permitted the common services to the other party in step 215. Specifically, the PIP server 150 determines whether the calling terminal 110 permits the common services to the called terminal 120 and vice versa. This determination is made by checking the policies of the calling and called terminals 110 and 120 about their common service capabilities. For example, the PIP server 150 determines whether each of the calling and called terminals 110 and 120 has opened its service capability to the other party and has permitted the common services to the other party. In the absence of any common service, the PIP server 150 configures service menu with the service capability information of the calling terminal 110 in step 227 and proceeds to step 221.

After step 215, the PIP server 150 determines whether there is any common service for which communication is permitted in step 217. For example, given PTA and IM as common services, if the called terminal 120 registers PTA as permitted and IM as non-permitted, a permitted common service exists. If the called terminal 120 registers both PTA and IM as non-permitted, there is no permitted common service.

In the presence of any permitted common service, the PIP server 150 proceeds to step 219 and in the absence of any permitted common service, it proceeds to step 227. In step 227, the PIP server 150 configures service menu with services available to the calling terminal 110. The PIP server 150 then proceeds to step 221.

In step 219, the PIP server 150 configures a service menu depending on whether services are permitted. Specifically, the PIP server 150 configures a service menu with the mutually permitted common services, and a service menu with other services available to the calling terminal 110, independent of the called terminal 120. In the above example, it is mandatory to display the permitted common services PTA and IM and other services available to the calling terminal 110, such as Multimedia Messaging Service (MMS) and IP TV as well as LBS can be additionally included.

The PIP server 150 determines whether to configure the service menu and provide it to the calling terminal 110 by a ring-back tone, or to provide only service menu configuration information, i.e. service menu information to the calling terminal 110 by a ring-back tone in step 221. Thus, the PIP server 150 configures the service menu and provides it to the calling terminal 110 by a ring-back tone in step 223, or provides only the service menu information to the calling terminal 110 by a ring-back tone so that the calling terminal 110 itself configures the service menu according to the service menu information in step 229.

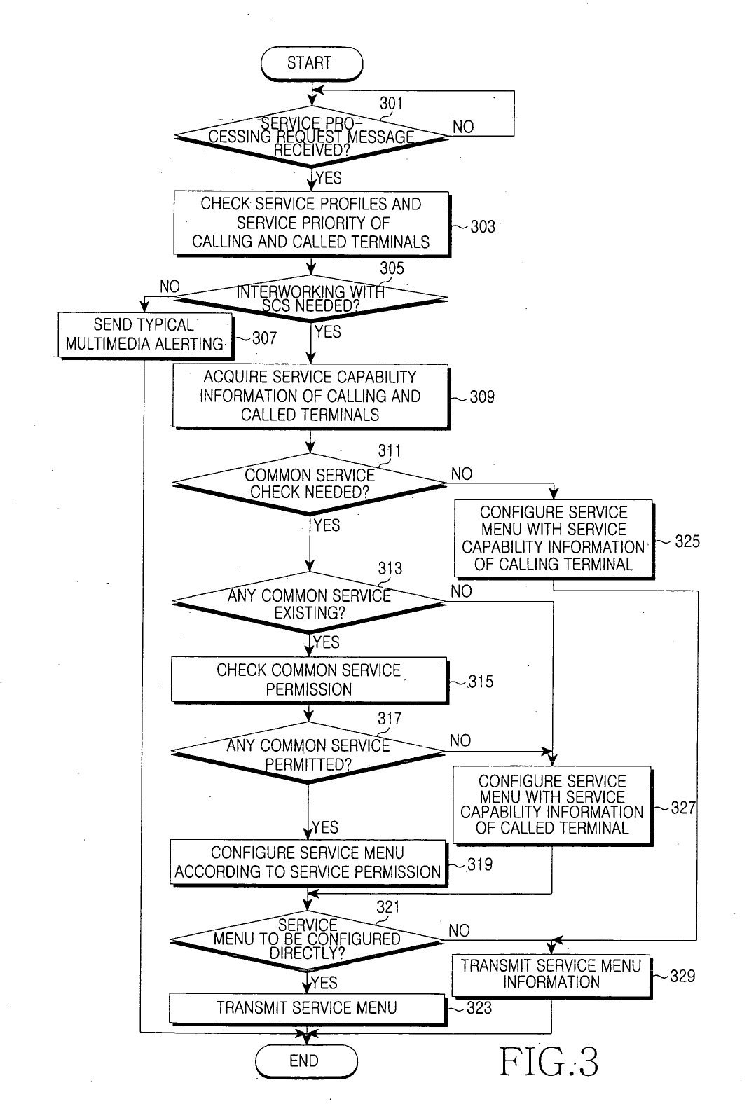

FIG. 3 is a flowchart illustrating an operation for configuring a service menu when the PIP server 150 provides a bell to the called terminal 120 according to the present invention.

Referring to FIG. 3, the PIP server 150 monitors reception of a service processing request message requesting a bell from the called terminal 120 in step 301. Upon receipt of the service processing request message, the PIP server 150 queries the DMS 190 about the service profiles and service priority of the calling and called terminals 110 and 120 in step 303.

In step 305, the PIP server 150 determines whether to interwork with the SCS 180, that is, whether the called terminal 120 has been set to receive service menu by providing an alerting service. If the called terminal 120 is set to receive the service menu information, the PIP server 150 proceeds to step 309. If the called terminal 120 is not to receive the service menu, the PIP server 150 configures a typical multimedia alerting and transmits it to the called terminal 120 in step 307.

If the PIP server 150 determines to interwork with the SCS 180 in step 305, it acquires the service capability information of the calling and called terminals 110 and 120 in step 309 and determines whether it is necessary to check the existence of any common service between the calling terminal 110 and the called terminal 120, considering common service check setting information preset by the called terminal 120 in step 311. If the common service check is needed, the PIP server 150 proceeds to step 313. If the common service check is not needed, the PIP server 150 configures service menu with the service capability information of the calling terminal 110 in step 325 and then proceeds to step 329.

In step 313, the PIP server 150 determines whether there is any common service between the calling terminal 110 and the called terminal 120. For example, if PTA, IM and LBS are available to the calling terminal 110 and PTA and IM are available to the called terminal 120, the PIP server 150 determines the existence of common services between them in step 313. That is, the PIP server 150 is aware that PTA and IM are common to the calling and called terminals 110 and 120, and LBS is confined to the calling terminal 110.

In the presence of any common service, the PIP server 150 determines whether the calling terminal 110 and the called terminal 120 each have permitted the common services to the other party in step 315. Specifically, the PIP server 150 determines whether the calling terminal 110 permits the common services to the called terminal and vice versa. This determination is made by checking the policies of the calling and called terminals 110 and 120 about their common service capabilities. For example, the PIP server 150 determines whether each of the calling and called terminals 110 and 120 has opened its service capability to the other party and has permitted the common services to the other party. In the absence of any common service, the PIP server 150 configures service menu with the service capability information of the called terminal 110 in step 327 and proceeds to step 321.

After step 315, the PIP server 150 determines whether there is any common service for which communication is permitted in step 317. For example, given PTA and IM as common services, if the calling terminal 110 registers PTA as permitted and IM as non-permitted, a permitted common service exists. If the calling terminal 110 registers both PTA and IM as non-permitted, there is no permitted common service.

In the presence of any permitted common service, the PIP server 150 proceeds to step 319 and in the absence of any common service, it configures a service menu with services available to the called terminal 120 in step 327. The PIP server 150 then proceeds to step 321.

In step 319, the PIP server 150 configures a service menu depending on whether services are permitted. Specifically, the PIP server 150 configures a service menu with the mutually permitted common services, and a service menu with other services available to the calling terminal 110, independent of the called terminal 120. In the above example, it is mandatory to display the permitted common services PTA and IM, and other services available to the calling terminal 110, such as MMS and IP TV as well as LBS can be additionally included.

The PIP server 150 determines whether to configure the service menu and provide it to the called terminal 120 by a bell, or to provide only service menu configuration information, i.e. service menu information to the called terminal 120 by a bell in step 321. Thus, the PIP server 150 configures the service menu and provides it to the called terminal 120 by a bell in step 323, or provides only the service menu information to the called terminal 120 by a bell so that the called terminal 120 itself configures the service menu according to the service menu information in step 329.

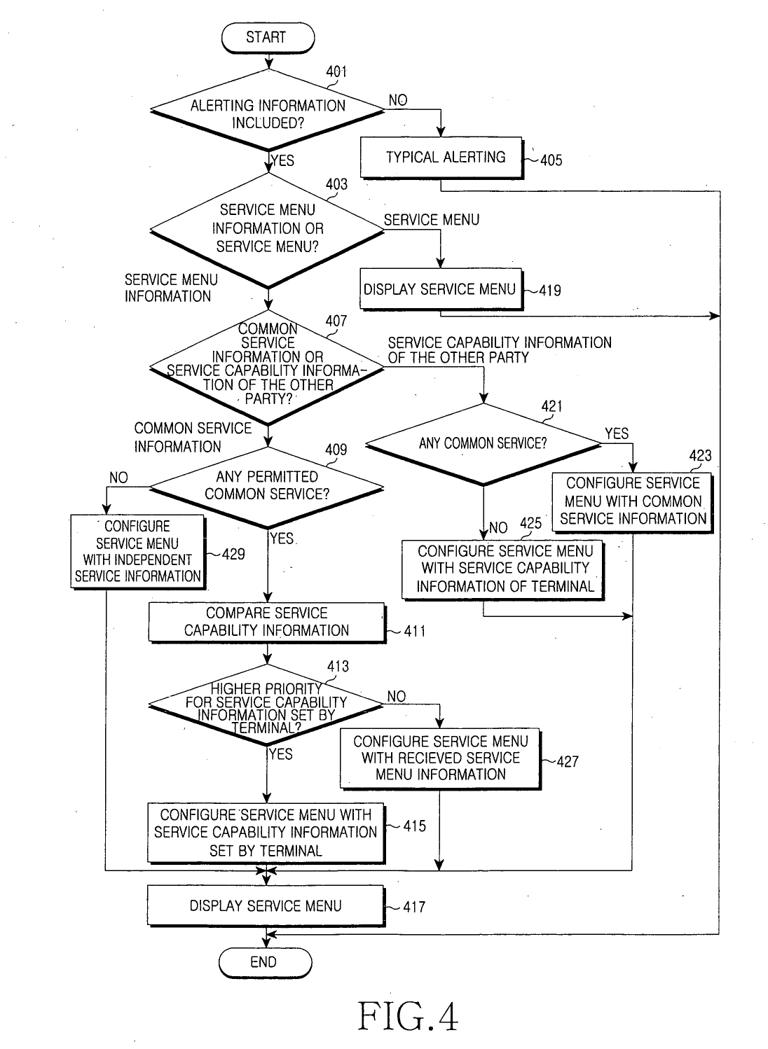

FIG. 4 is a flowchart illustrating an operation for displaying a service menu received from the PIP server 150 in the calling terminal 110 or the called terminal 120 according to the present invention. For notational simplicity, the calling terminal 110 and the called terminal 120 will each be referred to as a terminal.

Referring to FIG. 4, the terminal monitors inclusion of alerting information in a message received from the PIP server 150 in step 401. If the message includes the alerting information, the terminal proceeds to step 403. If the message does not include the alerting information, the terminal alerts its user in a conventional manner in step 405.

In step 403, the terminal determines whether the received alerting information includes service menu configuration information, i.e. service menu information or service menu. In case of the service menu, the terminal only displays the received service menu screen in step 419. When the PIP server 150 configures a service menu directly, the service menu is transmitted to the terminal by the alerting information.

In case of the service menu information, the terminal determines whether the service menu information is common service information or the service capability information of the other party in step 407. If the service menu information is common service information, the terminal proceeds to step 409. If the service menu information is the service capability information of the other party, the terminal proceeds to step 421.

In step 421, the terminal compares its service capability information with the service capability information of the other party to find common services. The common services refer to services that both the calling and called terminals can receive.

In the presence of any common service, the terminal configures a service menu with the common services in step 423 and proceeds to step 417. In the absence of any common service, the terminal configures a service menu with its service capability information in step 425 and proceeds to step 417.

If the service menu information is common service information in step 407, the terminal determines whether the common service information includes any permitted common service in step 409. In the absence of any permitted common service, the terminal configures a service menu with services independent of the other terminal in step 429.

In the presence of any permitted common service, the terminal compares the service capability information of the permitted communication services with service capability information stored in the terminal in step 411. The terminal then determines whether the service capability information of the permitted common services has a higher priority than the service capability information stored in the terminal in step 413. If the stored service capability information is higher in priority, the terminal configures a service menu with the stored service capability information in step 415 and proceeds to step 417. If the service capability information set by the PIP server 150, i.e. the service capability information of the permitted common services is higher in priority, the terminal configures a service menu with the received service menu information in step 427 and proceeds to step 417. For example, assuming that the PIP server 150 tells the terminal that PTA and IM are permitted common services between the terminal and the other terminal and the terminal is set to provide only PTA, when the terminal thinks that its service capability information has priority over a service capability information of the received service menu information, it configures a service menu with PTA only. If the service capability information set by the PIP server has a higher priority, the terminal configures a service menu with PTA and IM.

The terminal displays the service menus in step 417.

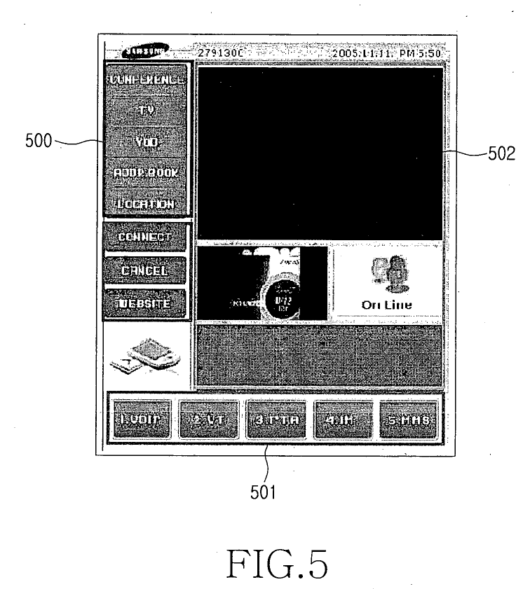

FIG. 5 illustrates a display of service menu information provided to the calling terminal 110 by a ring-back tone according to the present invention.

Referring to FIG. 5, reference numeral 500 denotes a service menu listing confined to only the service capability of the calling terminal 110, independent of the called terminal 120 in a comparison between the service capabilities of the calling and called terminals 110 and 120. If the user of the calling terminal 110 selects one of the displayed service menus 500, the calling terminal 10 provides service according to the selected service menu independent of an on-going call and operates according to a command entered by the user. The service menu 500 can be displayed by receiving service menu about services available to the calling terminal 110 during registration to the PIP server 150 after power-on.

Reference numeral 501 denotes a service menu listing common services that can be provided in relation to the called terminal 120 in a comparison between the service capabilities of the calling and called terminals 110 and 120. If the user of the calling terminal 110 selects one of the displayed services 501, the calling terminal 110 can request a connection for the selected service to a terminal currently connected to the calling terminal 110.

The service menus 500 and 501 can be displayed by receiving service menu configured by the PIP server 150 or service menu configuration information, i.e. service menu information from the PIP server 150 and configuring a service menu according to the service menu information.

A screen part 502 includes presence information such as ring-back tone multimedia received from the PIP server 150, and can display advertisement flash icons, and a message preset by the called user. Contents displayed on the screen part 502 are provided by the PIP server 150.

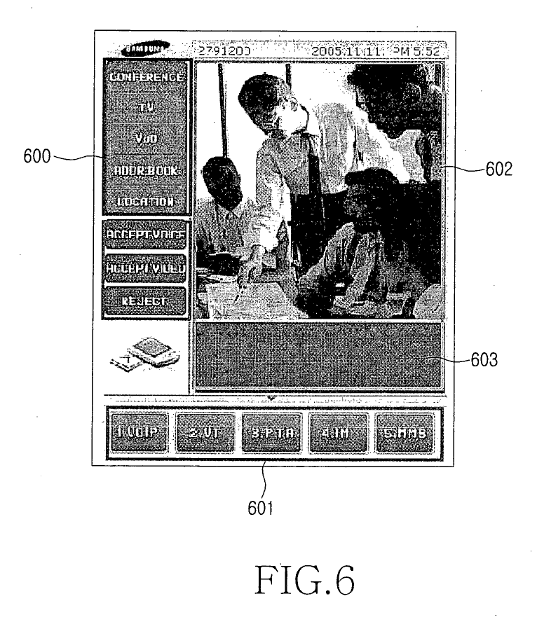

FIG. 6 illustrates a display of service menu information provided to the called terminal 120 by a bell sound according to the present invention.

Referring to FIG. 6, reference numeral 600 denotes a service menu listing confined to only the service capability of the called terminal 120, independent of the calling terminal 110 in a comparison between the service capabilities of the calling and called terminals 110 and 120. If the user of the called terminal 120 selects one of the displayed service menus 600, the called terminal 120 provides service according to the selected service menu independent of an on-going call and operates according to a command entered by the user.

Reference numeral 601 denotes a service menu listing common services that can be provided in relation to the calling terminal 110 in a comparison between the service capabilities of the calling and called terminals 110 and 120. If the user of the called terminal 120 selects one of the displayed services 601, the called terminal 120 can request a connection for the selected service to a terminal currently connected to the called terminal 120.

The service menus 600 and 601 can be displayed by receiving service menu configured by the PIP server 150 or service menu configuration information, i.e. service menu information from the PIP server 150 and configuring a service menu according to the service menu information.

A screen part 602 displays bell multimedia received from the PIP server 150, and can include a photo of the caller and his business card information. When necessary, an advertisement flash box 603 may display a message preset by the called user. Contents displayed on the screen parts 602 and 603 are provided by the PIP server 150.

In accordance with the present invention as described above, service menu is provided to a calling terminal or a called terminal by a ring-back tone or a bell, considering the service capability information and service permission information of the calling and called terminals. Therefore, the calling and called terminals are aware of mutually available services. A check of mutually available services on the part of a caller prevents a communication failure caused by the discrepancy in communication schemes, which may occur when the caller attempts to call in a communication scheme available only to the calling terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for providing a service menu in a communication system, the systems comprising:
a first server including a calling terminal and a called terminal, for comparing service capability information of the calling terminal with service capability information of the called terminal, when it is necessary to evaluate the service capability information of the calling and called terminals, and providing service menu to the calling and called terminals according to the comparison; and
a second server for providing the service capability information of the calling and called terminals to the first server.

2. The system of claim 1, wherein the first server provides the service capability information of the called terminal as the service menu to the calling terminal, when it is not necessary to evaluate the service capability information.

3. The system of claim 1, wherein the first server provides the service capability information of the calling terminal as the service menu to the called terminal, when it is not necessary to evaluate the service capability information.

4. The system of claim 1, wherein the first server checks common service using common service capability information from the service capability information of the calling and called terminals and provides the common service as the service menu to the calling and called terminals.

5. The system of claim 1, wherein the first server configures service menu information according to the service menu and provides the service menus information to the calling and called terminals.

6. The system of claim 1, wherein the first server detects a common service between the calling terminal and the called terminal, determines whether any of the common services is permitted for communication, and provides the service menu according to the determination.

7. The system of claim 6, wherein in the presence of any permitted common service, the first server provides a permitted common service as the service menu and in the absence of any permitted common service, the first server provides the service capability information of the calling and called terminals as the service menu to the calling and called terminals.

8. A method for providing a service menu in a communication system, the method comprising:
transmitting, by a calling terminal, a call setup request message including a service menu request;
comparing, by a first server, service capability information of the calling terminal with service capability information of a called terminal, when it is necessary to evaluate the service capability information of the calling and called terminals, upon receipt of the call setup request message; and
providing, by the first server, service menu to the calling and called terminals according to the comparison.

9. The method of claim 8, wherein providing the service capability information of the called terminal as the service menu to the calling terminal, when it is not necessary to evaluate the service capability information.

10. The method of claim 8, wherein providing the service capability information of the calling terminal as the service menu to the called terminal, when it is not necessary to evaluate the service capability information.

11. The method of claim 8, wherein providing the service menu comprises checking common service menu information using common service capability information from the service capability information of the calling and called terminals and providing the common service menu information to the calling and called terminals.

12. The method of claim 8, wherein providing the service menu comprises configuring service menu information according to the service menu and providing the service menu information to the calling and called terminals.

13. The method of claim 8, wherein providing the service menu comprises detecting a common service between the calling terminal and the called terminal, determining whether any of the common services is permitted for communication, and providing the service menu according to the determination.

14. The method of claim 8, wherein providing the service menu comprises providing a permitted common service as the service menu, in the presence of any permitted common service and providing the service capability information of the calling and called terminals as the service menu, in the absence of any permitted common service.

15. A system for providing a service menu in a communication system, the system comprising:
a calling terminal for setting to receive service menu and transmitting a call setup request including a service menu request;
a called terminal for setting to receive the service menu by a bell, receiving the service menu and outputting the service menu by a bell;
a first server for comparing service capability information of the calling terminal with service capability information of the called terminal, upon receipt of the call setup request from the calling terminal, when it is necessary to evaluate the service capability information of the calling and called terminals, and providing common service capability information as the service menu to the calling terminal if the calling and called terminals have common services; and
a second server for providing the service capability information of the calling and called terminals to the first server.

16. The system of claim 15, wherein the first server provides the service capability information of the called terminal as the service menu to the calling terminal, when it is not necessary to evaluate the service capability information.

17. The system of claim 15, wherein the first server is a Personal Internet Protocol Multimedia Subsystem (IMS) Portal (PIP) server.

18. The system of claim 15, wherein the first server provides the service capability information of the calling terminal as the service menu to the calling terminal, in the absence of any common service.

19. The system of claim 15, wherein the first server determines whether each of the calling terminal and the called terminal has permitted the common services to the other party and provides permitted common services as the service menu.

20. The system of claim 19, wherein the first server separates the permitted common services from services confined to the calling terminal and independent of the called terminal, and provides the permitted common services and the independent services as the service menu.

21. The system of claim 19, wherein the first server configures a service menu information according to the service menu and provides the service menu information to the calling terminal.

22. The system of claim 19, wherein the service capability information indicates services subscribed to by users of the calling terminal and the called terminal.

23. A method for providing a service menu in a communication system, the method comprising
setting, by a calling terminal, to receive service menu by a ring-back tone and transmitting a call setup request including a service menu request;
comparing, by a first server, service capability information of the calling terminal with service capability information of a called terminal, upon receipt of the call setup request from the calling terminal, when it is necessary to evaluate the service capability information of the calling and called terminals; and
providing, by a first server, common service capability information as service menu to the calling terminal, if the calling and called terminals have common services.

24. The method of claim 23, wherein providing the service capability information of the called terminal as the service menu to the calling terminal, when it is not necessary to evaluate the service capability information.

25. The method of claim 23, wherein the first server is a Personal Internet Protocol Multimedia Subsystem (IMS) Portal (PIP) server.

26. The method of claim 23, wherein providing the service capability information of the calling terminal as the service menu to the calling terminal, in the absence of any common service.

27. The method of claim 23, wherein providing common service capability information comprises determining whether each of the calling terminal and the called terminal has permitted the common services to the other party and providing information about the common services as the service menu according to the determination.

28. The method of claim 27, wherein providing information about the common services as the service menu according to the determination comprises separating the permitted common services from services confined to the calling terminal and independent of the called terminal, and providing the permitted common services and the independent services as the service menu.

29. The method of claim 23, wherein providing common service capability information comprises configuring a service menu information according to the service menu and providing the service menu information to the calling terminal.

30. The method of claim 23, wherein the service capability information indicates services subscribed to by users of the calling terminal and the called terminal.

31. A system for providing a service menu in a communication system, the system comprising:
a calling terminal for being set to receive service menu by a ring-back tone and transmitting a call setup request including a service menu request;
a called terminal for being set to receive the service menu by a bell, receiving the service menu, and outputting the service menu by a bell;
a first server for comparing service capability information of the calling terminal with service capability information of the called terminal, upon receipt of the call setup request from the calling terminal, when it is necessary to evaluate the service capability information of the calling and called terminals, and providing common service capability information as the service menu to the called terminal if the calling and called terminals have common services; and
a second server for providing the service capability information of the calling and called terminals to the first server.

32. The system of claim 31, wherein the first server provides the service capability information of the calling terminal as the service menu to the called terminal, when it is not necessary to evaluate the service capability information.

33. The system of claim 31, wherein the first server is a Personal Internet Protocol Multimedia Subsystem (IMS) Portal (PIP) server.

34. The system of claim 31, wherein the first server provides the service capability information of the called terminal as the service menu to the called terminal, in the absence of any the common service.

35. The system of claim 31, wherein the first server determines whether each of the calling terminal and the called terminal has permitted the common services to the other party and provides information about permitted common services as the service menu.

36. The system of claim 35, wherein the first server separates the permitted common services from services confined to the called terminal and independent of the calling terminal, and provides the permitted common services and the independent services as the service menu.

37. The system of claim 31, wherein the first server configures a service menu information according to the service menu and provides the service menu information to the called terminal.

38. The system of claim 31, wherein the service capability information indicates services subscribed to by users of the calling terminal and the called terminal.

39. A method for providing a service menu in a communication system, the method comprising:
setting, by a called terminal, to receive service menu by a bell;
comparing, by a first server, service capability information of a calling terminal with service capability information of the called terminal, upon receipt of a call setup request from the calling terminal, when it is necessary to evaluate the service capability information of the calling and called terminals; and
providing, by a first server, common service capability information as service menu to the called terminal, if the calling and called terminals have common services.

40. The method of claim 39, wherein providing the service capability information of the calling terminal as the service menu to the called terminal, when it is not necessary to evaluate the service capability information.

41. The method of claim 39, wherein the first server is a Personal Internet Protocol Multimedia Subsystem (IMS) Portal (PIP) server.

42. The method of claim 39, wherein providing the service capability information of the called terminal as the service menu to the called terminal, in the absence of any common service.

43. The method of claim 39, wherein providing common service capability information comprises determining whether each of the calling terminal and the called terminal has permitted the common services to the other party and providing information about the common services as the service menu according to the determination.

44. The method of claim 43, wherein providing information about the common services as the service menu information according to the determination comprises separating the permitted common services from services confined to the called terminal and independent of the calling terminal, and providing the permitted common services and information about the independent services as the service menu.

45. The method of claim 39, wherein providing common service capability information comprises configuring a service menu information according to the service menu and providing the service menu information to the called terminal.

46. The method of claim 39, wherein the service capability information indicates services subscribed to by users of the calling terminal and the called terminal.

47. A method for receiving service menu at a calling terminal in a communication, the method comprising:
determining, upon receipt of a message including alerting information, whether the alerting information includes service menu information;
determining whether the service menu information is common service information or service capability information of a called terminal, if the alerting information includes the service menu information; and
displaying a service menu according to the service menu information is service menu, if the service menu information is the common service information.

48. The method of claim 47, wherein displaying a service menu comprises determining whether the common service information exists between service capability information of the calling terminal and the service capability information of the called terminal, if the service menu information is the service capability information of the called terminal and displaying the common service information, in the presence of the common service information.

49. The method of claim 48, wherein displaying a service menu comprises the service capability information of the calling terminal, in the absence of the common service information.

50. The method of claim 47, wherein displaying a service menu comprises displaying the service menu if the service menu information is the service menu.

51. The method of claim 47, wherein displaying a service menu comprises comparing service capability information of the service menu with service capability information stored in the calling terminal, and displaying the service capability information with having a higher priority as the service menu.

52. The method of claim 51, wherein displaying the service capability information comprises displaying the service capability information of the service menu, if the service capability information of the service menu has a higher priority.

53. The method of claim 51, wherein displaying the service capability information comprises displaying the service capability information stored in the calling terminal, if the service capability information stored in the calling terminal has a higher priority.

54. A method for receiving service menu information at a called terminal in a communication system, the method comprising:
determining, upon receipt of a message including alerting information, whether the alerting information includes service menu information;
determining whether the service menu information is common service information or service capability information of a calling terminal, if the alerting information includes the service menu information; and
displaying a service menu according to the service menu information is service menu, if the service menu information is the common service information.

55. The method of claim 54, wherein displaying a service menu comprises determining whether the common service information exists between service capability information of the calling terminal and the service capability information of the called terminal, if the service menu information is the service capability information of the calling terminal and displaying the common service information, in the presence of the common service information.

56. The method of claim 55, wherein displaying a service menu comprises the service capability information of the called terminal, in the absence of the common service information.

57. The method of claim 54, wherein displaying a service menu comprises-displaying the service menu if the service menu information is the service menu.

58. The method of claim 54, wherein displaying a service menu comprises comparing service capability information of the service menu with service capability information stored in the called terminal, and displaying the service capability information with having a higher priority as the service menu.

59. The method of claim 58, wherein displaying the service capability information comprises displaying the service capability information of the service menu, if the service capability information of the service menu has a higher priority.

60. The method of claim 58, wherein displaying the capability information comprises displaying the service capability information stored in the called terminal, if the service capability information stored in the called terminal has a higher priority.
